(19) United States
(12) Patent Application Publication
(10) Pub. No.: US 2016/0373653 A1
(43) Pub. Date: Dec. 22, 2016

(54) METHOD FOR PROCESSING IMAGE AND ELECTRONIC DEVICE THEREOF

(71) Applicant: Samsung Electronics Co., Ltd., Gyeonggi-do (KR)

(72) Inventors: Minkyu Park, Seoul (KR); Kihuk Lee, Suwon-si (KR); Yonggu Lee, Seoul (KR)

(21) Appl. No.: 15/186,351

(22) Filed: Jun. 17, 2016

(30) Foreign Application Priority Data
Jun. 19, 2015 (KR) 10-2015-0087577

(51) Int. Cl. H04N 5/232

(52) U.S. Cl. CPC H04N 5/23277; H04N 5/23254

(57) ABSTRACT

An electronic device that includes various components for processing an image. The electronic device can include an image sensor configured to acquire one or more images including a same object. Additionally, the electronic device can include a pre-processing unit configured to generate one or more pre-processed images by changing a part of the one or more images. The electronic device can also include an image signal processing unit configured to generate a post-processed image by changing a second part of the one or more pre-processed images.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jun. 19, 2015 and assigned Serial No. 10-2015-0087577, the contents of which are incorporated herein by reference.

### TECHNICAL FIELD

Embodiments of the present disclosure relate to an electronic device which processes an image acquired in an image sensor and an operation control method thereof.

### BACKGROUND

Thanks to the recent development of digital technology, various methods for processing digital images are increasingly developing. A representative electronic device for processing digital images includes a digital camera, a smart phone, a tablet, a personal computer (PC), etc.

The electronic device may be provided with a camera module and an image signal processor. The camera module may convert optical signals entering through a lens into image data, and the image signal processor may display the image data as a preview image and process the image data into moving picture data or still image data and store the image data.

### SUMMARY

The brightness of image signals in an image processing device may be determined by adjusting exposure time or gain. For example, exposure time may be extended or the gain increased in order to make an image appear brighter. However, these adjustments may degrade an image in other ways. For instance, when the exposure time is extended to make an image brighter, an undesirable motion blur may occur since image processing is susceptible to the motion of an object. Similarly, when the gain is increased to make an image brighter, noise may increase, thus degrading the image overall. Accordingly, it is desirable for an image processing device to acquire an image with minimal deterioration and with a short exposure time.

An aspect of the present disclosure is to solve at least the above-mentioned problems and/or disadvantages and to provide at least the advantages described below. Accordingly, an aspect of the present disclosure provides an electronic device which can acquire and process an image without degrading image quality or reducing degradation thereof, while reducing exposure time, and a method thereof.

Another aspect of the present disclosure provides an electronic device configured to scale an image of a Bayer format to an image of an RGB format using an intra-frame sum, and then process the image, and a method thereof.

Another aspect of the present disclosure provides an electronic device configured to generate a still image by combining buffered images when capturing a still image, and then process the still image, and a method thereof.

Another aspect of the present disclosure provides an electronic device configured to perform pre-processing to down-scale dynamic image signals (for example, a moving picture or a camera preview) acquired through an image sensor, so that a bright image can be acquired with less exposure time and a quantity of operation for processing an image can be reduced, and a method thereof.

Another aspect of the present disclosure provides an electronic device configured to combine static image signals (for example, a captured image or a still image) acquired through an image sensor with previous and next static image signals, so that a bright image can be acquired with less exposure time and a quantity of operation for processing an image can be reduced, and a method thereof.

According to another aspect of the present disclosure, an electronic device includes: an image sensor configured to acquire one or more images regarding an object; a pre-processing unit configured to generate one or more pre-processed images by changing a part of the one or more images; and an image signal processing unit configured to generate a post-processed image by changing a part of the one or more pre-processed images.

According to another aspect of the present disclosure, a method of operating an electronic device which includes a pre-processing unit and an image signal processing unit. the method including: acquiring one or more images regarding an object through an image sensor operatively connected with the electronic device; generating, by the pre-processing unit, one or more pre-processed images by changing a part of the one or more images; and generating, by the image signal processing unit, a post-processed image by changing a part of the one or more pre-processed images.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic illustrating a network environment including an electronic device according to embodiments of the present disclosure;

FIG. 2 is a block diagram illustrating an electronic device according to embodiments of the present disclosure;

FIG. 3 is a block diagram illustrating a program module according to embodiments of the present disclosure;

FIG. 4 is a schematic illustrating an electronic device for processing an image according to an embodiment of the present disclosure;

FIG. 5 is a block diagram illustrating a function of an electronic device according to embodiments of the present disclosure;

FIG. 6 is a schematic illustrating a low-pixel pre-processing unit according to embodiments of the present disclosure;

FIG. 7 is a schematic illustrating an operation of scaling an image using an image scaler according to embodiments of the present disclosure;

FIG. 8 is a schematic illustrating an example operation of generating an RGB image using an intra-frame sum according to embodiments of the present disclosure;

FIG. 9 is a schematic illustrating graphs displaying image data according to embodiments of the present disclosure;

FIG. 10 is a block diagram illustrating a procedure for processing image data in a high-pixel pre-processing unit according to embodiments of the present disclosure;

FIG. 11 is a block diagram illustrating a flow of images in the high-pixel pre-processing unit according to embodiments of the present disclosure;

FIG. 12 is a block diagram illustrating a procedure for processing image data in the high-pixel pre-processing unit according to embodiments of the present disclosure;

FIG. 13 is a block diagram illustrating a flow of images in the high-pixel pre-processing unit according to embodiments of the present disclosure;

FIG. 14 is a schematic illustrating image data to which a High Dynamic Range (HDR) effect is applied according to embodiments of the present disclosure;

FIG. 15 is a flowchart illustrating an operation of processing image data in the electronic device according to embodiments of the present disclosure;

FIG. 16 is a flowchart illustrating an operation of calculating an intra-frame sum in the low-pixel pre-processing unit according to embodiments of the present disclosure;

FIG. 17 is a flowchart illustrating an operation of calculating an inter-frame sum in the high-pixel pre-processing unit according to embodiments of the present disclosure;

FIG. 18 is a flowchart illustrating another operation of calculating an inter-frame sum in the high-pixel pre-processing unit according to embodiments of the present disclosure;

FIG. 19 is a flowchart illustrating an operation of the electronic device according to embodiments of the present disclosure; and

FIG. 20 is a flowchart illustrating an operation of the electronic device according to embodiments of the present disclosure.

### DETAILED DESCRIPTION

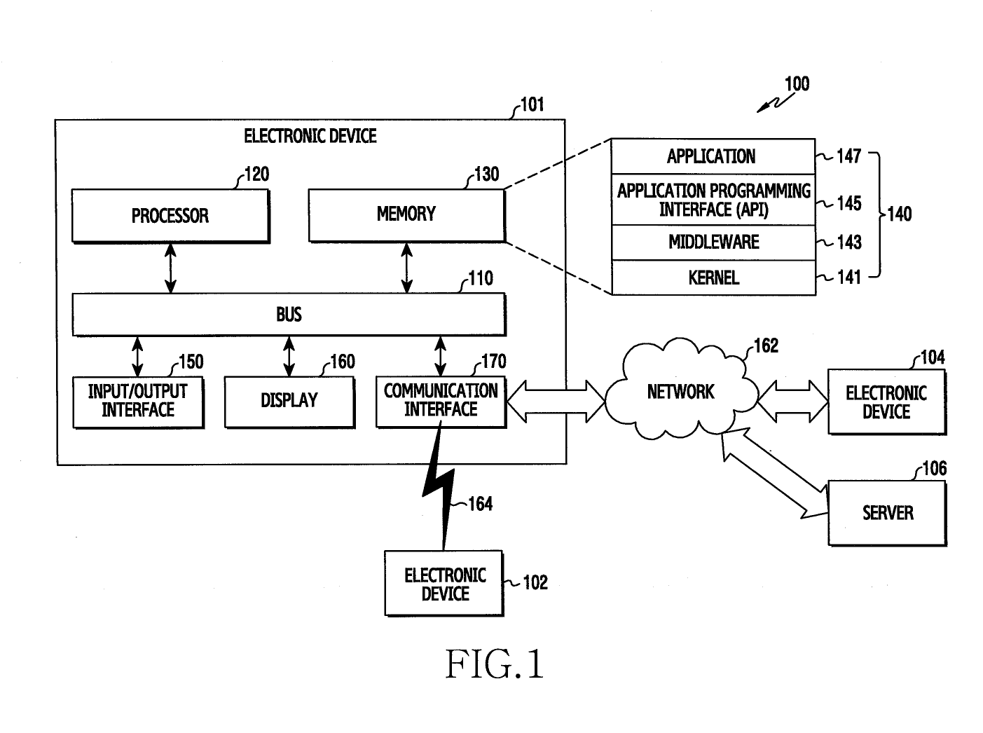

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged configuration in an electronic device.

Hereinafter, embodiments of the present disclosure are described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the terms “have”, “may have”, “include”, or “may include” refer to the existence of disclosed corresponding features (e.g., numerals, functions, operations, or constituent elements such as components), and do not preclude the presence or addition of one or more additional features.

In the present disclosure, the expression “A or B”, “at least one of A or/and B”, or “one or more of A or/and B” may include any and all possible combinations of the items listed. For example, the expression “A or B”, “at least one of A and B”, or “at least one of A or B” refers to all of (1) including at least one A, (2) including at least one B, or (3) including all of at least one A and at least one B.

Although terms such as “a first”, “a second”, “the first”, or “the second” used in various embodiments of the present disclosure may modify various elements of the various embodiments, these terms do not limit the corresponding elements. For example, these terms do not limit an order or an importance of the corresponding components. These terms may instead be used for the purpose of distinguishing one element from another element. For example, a first user device and a second user device may indicate different user devices although both of them are user devices. As an additional example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), the element may be directly connected or coupled directly to the other element, and there may be an intervening element (e.g., third element) interposed between the element and the other element. In contrast, it will be understood that when an element (e.g., first element) is referred to as being “directly connected,” or “directly coupled” to another element (second element), there is no intervening element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) used for performing the corresponding operations or a generic-purpose processor (e.g., a central processing unit (CPU) or an application processor (AP), that can perform a corresponding operation by executing one or more software programs stored in a memory device.

The terms used in the present disclosure are used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to embodiments of the present disclosure may include at least one of a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), an MP3 player, a mobile medical device, a camera, a power bank, or a wearable device (e.g., a head-mount-device (HMD), an electronic glasses, an electronic clothing, an electronic bracelet, an electronic watch, an electronic ring, an electronic anklet, an electronic necklace, an electronic accessory, or an electronic contact lens), a body-mounted type (e.g., a skin pad, or tattoo), and a bio-implantable type (e.g., an implantable circuit)).

An electronic device according to embodiments of the present disclosure may be a home appliance. The home appliance may include at least one of: a television, a digital video disk (DVD) player, an audio component, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV®), a game console (e.g., Xbox® or PlayStation®), an electronic dictionary, an electronic key, a camcorder, and an electronic photo frame.

According to another embodiment, the electronic device may include at least one of various medical devices (e.g., portable medical measuring devices (e.g., a blood glucose monitoring device, a heart rate monitoring device, a blood pressure measuring device, a body temperature measuring device, etc.), a magnetic resonance angiography (MRA) machine, a magnetic resonance imaging (MRI) machine, a computed tomography (CT) scanner, or an ultrasonic machine), a navigation device, a global positioning system (GPS) receiver, an event data recorder (EDR), a flight data recorder (FDR), an in-vehicle infotainment device, an electronic device for a ship (e.g., a ship navigation device or a gyrocompass), avionics devices, security devices, a head unit for a vehicle, a robot for home or industry, an automatic teller's machine (ATM) of a financial institution, point of sales (POS) device at a retail store, or an internet of things device (e.g., a light bulb, various sensors, an electric or gas meter, a sprinkler device, a fire alarm, a thermostat, a streetlamp, a toaster, sporting equipment, a hot water tank, a heater, a boiler, etc.).

According to embodiments of the present disclosure, an electronic device may include at least one of a piece of furniture or a building or structure, an electronic board, an electronic signature receiving device, a projector, and various kinds of measuring instruments (e.g., a water meter, an electric meter, a gas meter, and a radio wave meter). The electronic device according to embodiments of the present disclosure may be a combination of one or more of the aforementioned devices. Additionally, the electronic device according to embodiments of the present disclosure may be a flexible device. Further, it will be apparent to those skilled in the art that an electronic device according to an embodiment of the present disclosure is not limited to the aforementioned devices, and may include a new electronic device according to the development of technology.

Hereinafter, the term “user” may indicate a person who uses an electronic device or a device (e.g., an artificial intelligence electronic device) that uses the electronic device.

FIG. 1 is a diagram illustrating a network environment including an electronic device according to embodiments of the present disclosure.

An electronic device 101 within a network environment 100, according to embodiments, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 120 to 170 and delivers a communication (e.g., a control message or data) between the components 120 to 170.

The processor 120 may include one or more of a central processing unit (CPU), an application processor (AP), or a communication processor (CP). The processor 120 may perform operations or data processing with respect to control or communication of at least one other element of the electronic device 101. According to an embodiment of the present disclosure, the processor 120 may perform an operation to receive first proximity service data and receive second proximity service data included in the first proximity service data using guide information which is used for receiving the second proximity service data. In addition, the processor 120 may control transmission of the first proximity service data including guide information which is used for receiving the second proximity service data.

The memory 130 may include at least one of a volatile memory or a non-volatile memory. For example, the memory 130 may store commands or data related to at least one other element of the electronic device 101. According to an embodiment, the memory 130 may store at least one of software or programs 140. The programs 140 may include at least one or more of a kernel 141, middleware 143, an application programming interface (API) 145, or an application program (or an application) 147, etc. At least part of the kernel 141, the middleware 143, or the API 145 may be referred to as an operating system (OS).

The kernel 141 may control or manage system resources (e.g., the bus 110, the processor 120, the memory 130, or the like) used for performing operations or functions implemented by the other programs (e.g., the middleware 143, the API 145, or the application program 147). Additionally, the kernel 141 may provide an interface for allowing the middleware 143, the API 145, or the application program 147 to access an individual element of the electronic device 101 and to control or manage the system resources.

The middleware 143 may serve as an intermediary for allowing the API 145 or the application program 147 to communicate with the kernel 141 and exchange data with the kernel 141. In addition, the middleware 143 may perform operations (e.g., scheduling or load balancing) for controlling work requests received from the application program 147, for example, by assigning a priority to each work request for using the system resources (e.g., the bus 110, the processor 120, the memory 130, or the like) of the electronic device 101 to at least one application of the application program 147.

The API 145 may be an interface for allowing the application 147 to control a function provided by the kernel 141 or the middleware 143, and may include, for example, at least one interface or function (e.g., instructions) for controlling a file, controlling a window, processing an image, or controlling a text.

The input/output interface 150 may serve as an interface for transmitting instructions or data input from a user or another external device to the other element(s) of the electronic device 101. Furthermore, the input/output interface 150 may output the instructions or data received from other element(s) of the electronic device 101 to the user or another external device.

Examples of the display 160 may include a liquid crystal display (LCD), a light-emitting diode (LED) display, an organic light-emitting diode (OLED) display, a microelectromechanical systems (MEMS) display, and an electronic paper display. The display 160 may display, for example, various types of contents (e.g., text, images, videos, icons, or symbols) to a user. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106).

The wireless communication may use at least one of, for example, long term evolution (LTE), LTE-Advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of Wi-Fi, Bluetooth®, near field communication (NFC), and global navigation satellite system (GNSS). GNSS may include, for example, at least one of global positioning system (GPS), global navigation satellite system (GLONASS), a Beidou Navigation satellite system (hereinafter referred to as “Beidou”), or GALILEO (European global satellite-based navigation system), based on a location, a bandwidth, or the like. Hereinafter, in the present disclosure, the “GPS” may be interchangeably used with the “GNSS”. The wired communication may include, for example, at least one of a universal serial bus (USB), a high definition multimedia interface (HDMI), recommended standard-232 (RS-232), and a plain old telephone service (POTS). The network 162 may include at least one of a communication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. According to embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 performs functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or further process the received result to provide the requested functions or services. To this end, for example, cloud computing, distributed computing, or client-server computing technologies may be used.

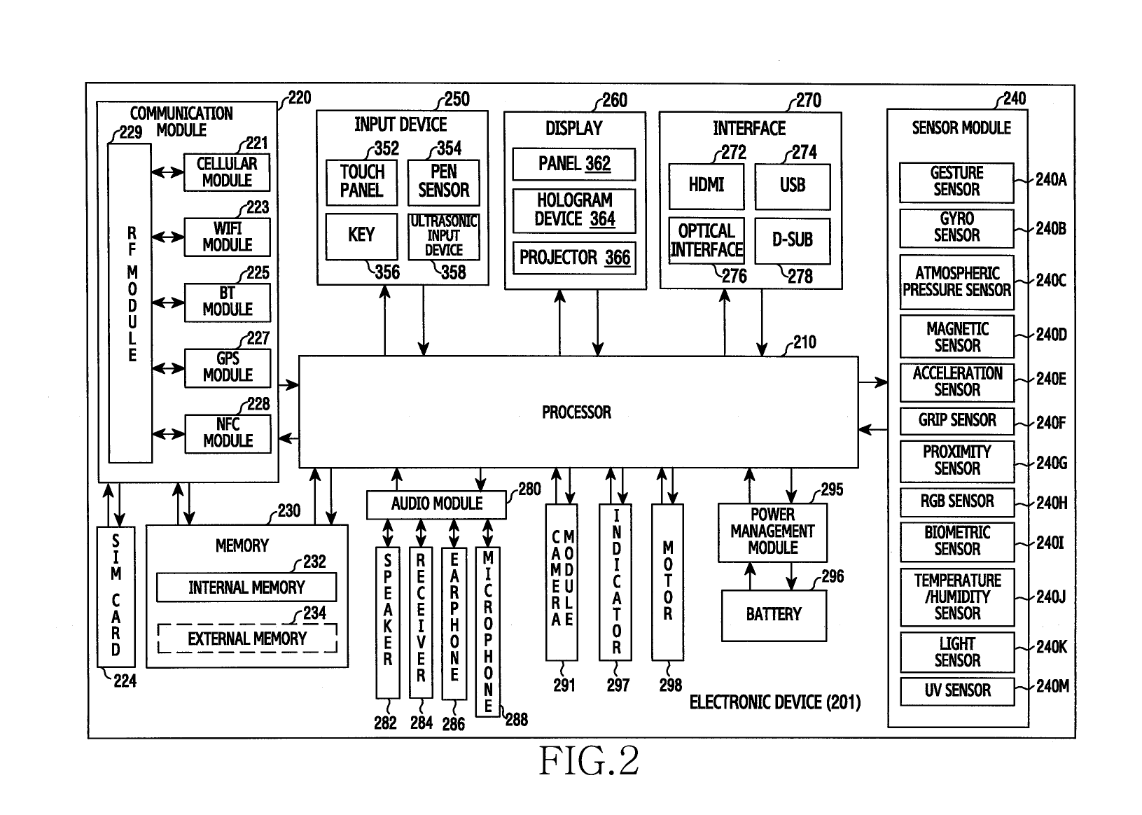

FIG. 2 is a block diagram illustrating an electronic device according to embodiments of the present disclosure.

The electronic device 201 may include, for example, all or a part of the electronic device 101 shown in FIG. 1. The electronic device 201 may include one or more processors 210 (e.g., application processors (AP)), a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected thereto and perform processing of pieces of data and calculations by driving an operating system or an application program. The processor 210 may be embodied as, for example, a system on chip (SoC). According to an embodiment of the present disclosure, the processor 210 may further include at least a graphic processing unit (GPU) or an image signal processor. The processor 210 may include at least some of the components (e.g., a cellular module 221) illustrated in FIG. 2. The processor 210 may load, into a volatile memory, commands or data received from at least one other component (e.g., a non-volatile memory) into a volatile memory to process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a BT module 225, a GPS module 227 (e.g., a GPS module 227, a GLANASS module, a Beidou module, or a GALILEO module), an NFC module 228, and a radio frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using a subscriber identification module 224 (e.g., the SIM card). According to an embodiment of the present disclosure, the cellular module 221 may perform at least some of the functions that the AP 210 may provide. According to an embodiment of the present disclosure, the cellular module 221 may include a communication processor (CP).

Each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in a single integrated chip (IC) or IC package.

The RF module 229, for example, may transmit/receive a communication signal (e.g., an RF signal). The RF module 229 may include, for example, a transceiver, a power amplifier module (PAM), a frequency filter, a low noise amplifier (LNA), and an antenna. According to an embodiment of the present disclosure, at least one of the cellular module 221, the WIFI module 223, the BT module 225, the GNSS module 227, and the NFC module 228 may transmit/receive an RF signal through a separate RF module.

The subscriber identification module 224 may include, for example, a card including a subscriber identity module or an embedded SIM, and may further include unique identification information (e.g., an integrated circuit card identifier (ICCID)) or subscriber information (e.g., an international mobile Subscriber Identity (IMSI)).

The memory 230 (e.g., the memory 130) may include, for example, an embedded memory 232 or an external memory 234. The embedded memory 232 may include at least one of a volatile memory (e.g., a dynamic random access memory (DRAM), a static RAM (SRAM), a synchronous dynamic RAM (SDRAM), or the like) and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), a hard disc drive, or a solid state drive (SSD)).

The external memory 234 may further include a flash drive, for example, a compact flash (CF), a secure digital (SD), a micro secure digital (Micro-SD), a mini secure digital (Mini-SD), an extreme digital (xD), a multi media card (MMC), a memory stick, or the like. The external memory 234 may be functionally and/or physically connected to the electronic device 201 through various interfaces.

The sensor module 240 may be configured to measure a physical quantity or detect an operation state of the electronic device 201, and convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 2401, a temperature/humidity sensor 240J, a light sensor 240K, and an ultra violet (UV) sensor 240M. Additionally or alternatively, the sensor module 240 may include one or more of an E-nose sensor, an electromyography (EMG) sensor, an electroencephalogram (EEG) sensor, an electrocardiogram (ECG) sensor, an infrared (IR) sensor, an iris scan sensor, and a finger scan sensor. The sensor module 240 may further include a control circuit for controlling one or more sensors included therein. According to an embodiment of the present disclosure, the electronic device 201 may further include another processor configured to control the sensor module 240, as a part of the processor 210 or a separate component from the processor 210 in order to control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a high-definition multimedia interface (HDMI) 272, a universal serial bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280, for example, may be configured to bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image, a moving image, or a video. According to an embodiment of the present disclosure, the camera module 291 may include one or more image sensors (e.g., a front sensor or a rear sensor), a lens, an image signal processor (ISP) or a flash (e.g., LED or xenon lamp).

The power management module 295 may manage, for example, power of the electronic device 201. According to an embodiment of the present disclosure, the power management module 295 may include a power management integrated circuit (PMIC), a charger integrated circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, at least one of a rechargeable battery and a solar battery.

The indicator 297 may indicate a state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standards such as digital multimedia broadcasting (DMB), digital video broadcasting (DVB), or media flow.

Each of the above-described hardware components of the electronic device 201 according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

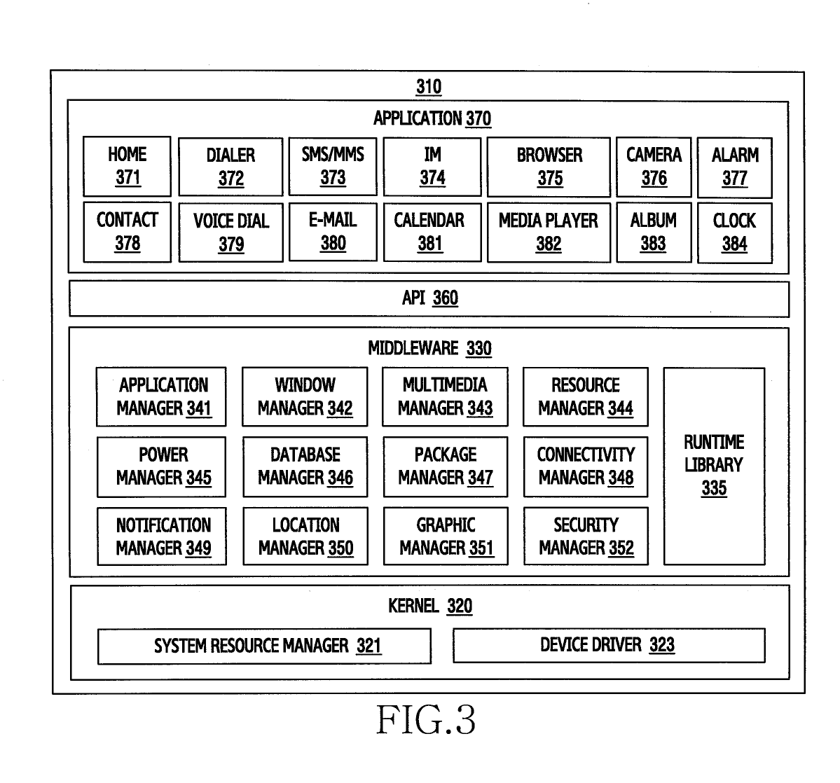

FIG. 3 is a block diagram illustrating a program module according to embodiments of the present disclosure.

According to an embodiment of the present disclosure, the program module 310 (e.g., the program 140) may include an operating system (OS) for controlling resources related to the electronic device (e.g., the electronic device 101) and/or various applications (e.g., the application 147) executed in the operating system. The operating system may be, for example, Android®, iOS®, Windows®, Symbian®, Tizen®, Bada®, or the like.

The program module 310 may include at least one of a kernel 320, middleware 330, an API 360, and an application 370. At least some of the program module 310 may be preloaded on an electronic device, or may be downloaded from an external electronic device (e.g., the electronic device 102, the electronic device 104, or the server 106).

The kernel 320 (e.g., the kernel 141) may include, for example, a system resource manager 321 or a device driver 323. The system resource manager 321 may control, allocate, or collect system resources. According to an embodiment of the present disclosure, the system resource manager 321 may include a process management unit, a memory management unit, or a file system management unit, and the like. The device driver 323 may include, for example, a display driver, a camera driver, a Bluetooth® driver, a shared memory driver, a USB driver, a keypad driver, a Wi-Fi driver, an audio driver, or an inter-process communication (IPC) driver.

For example, the middleware 330 may provide a function utilized in common by the application 370, or may provide various functions to the applications 370 through the API 360 so as to enable the applications 370 to efficiently use limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, or a functionality for an arithmetic function, or the like.

The application manager 341 may manage, for example, a life cycle of at least one of the applications 370. The window manager 342 may manage graphical user interface (GUI) resources used by a screen. The multimedia manager 343 may identify a format utilized for reproduction of various media files, and may encode or decode a media file by using a codec suitable for the corresponding format. The resource manager 344 may manage resources such as a source code, a memory, and a storage space of at least one of the applications 370.

The power manager 345 may operate together with, for example, a basic input/output (BIOS) or the like to manage a battery or power source and may provide power information utilized for operation of the electronic device. The database manager 346 may generate, search, or change a database to be used by at least one of the applications 370. The package manager 347 may manage installation or update of an application distributed in the format of a package file.

For example, the connectivity manager 348 may manage wireless connectivity such as Wi-Fi or Bluetooth®. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide security functions utilized for system security or user authentication, or the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of operating system (OS) in order to provide a differentiated function. Further, the middleware 330 may dynamically remove or delete some of the existing components or add new components.

The API 360 (e.g., the API 145) includes, for example, a set of API programming functions, and may be provided with different configurations according to operating systems. For example, in the case of Android® or iOS®, one API set may be provided for each platform. In the case of Tizen®, two or more API sets may be provided for each platform.

The applications 370 (e.g., the application 147) may include, for example, one or more applications which may provide functions such as a home 371, a dialer 372, a short message service (SMS)/multimedia message service (MMS) 373, an instant message (IM) 374, a browser 375, a camera 376, an alarm 377, contacts 378, a voice dial 379, an email 380, a calendar 381, a media player 382, an album 383, a clock 384, a health care (e.g., to measure exercise quantity or blood sugar), or environment information (e.g., atmospheric pressure, humidity, or temperature information).

According to an embodiment of the present disclosure, the applications 370 may include an application (hereinafter, referred to as an “information exchange application” for convenience of description) that supports information exchange between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to an external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

A device management application may manage (e.g., install, delete, or update), for example, at least one function of an external electronic device (e.g., the electronic device 102 or 104) communicating with the electronic device (e.g., a function of turning on/off the external electronic device itself (or some components thereof) or a function of adjusting a brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to attributes corresponding to an external electronic device (e.g., attributes of the electronic device 102 or 104). According to an embodiment of the present disclosure, the applications 370 may include an application received from an external electronic device (e.g., the server 106, or the electronic device 102 or 104). According to an embodiment of the present disclosure, the applications 370 may include a preloaded application or a third party application that may be downloaded from a server. The names of the components of the program module 310, according to the embodiment illustrated in FIG. 3, may vary according to the type of operating system.

According to some embodiments, at least a part of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

According to various exemplary embodiments of the present disclosure, in processing an image acquired in an image sensor, the electronic device may pre-process the image so as to have an effect of acquiring a bright image without losing exposure time or at least minimizing loss thereof, by calculating an intra-frame sum or an inter-frame sum with respect to the image acquired in the image sensor according to an image processing mode. Additionally or alternatively, the electronic device may process the pre-processed image to display or store. First, when the image is to be scaled, the electronic device may perform the pre-processing operation to convert the image acquired in the image sensor into an RGB image by calculating the intra-frame sum, process the pre-processed image, and store the image as a preview image or a moving picture. Second, when the image is to be processed into a still image (e.g., a still image or a captured image), the electronic device may buffer the image acquired in the image sensor, set the image as a still image by calculating the inter-frame sum of the buffered image, process the set image, and store as a still image. The set image may be an image generated by selecting an image that includes a least amount of blur as a reference image, comparing the buffered image and the selected reference image, and then compensating for a motion of an object included in the image.

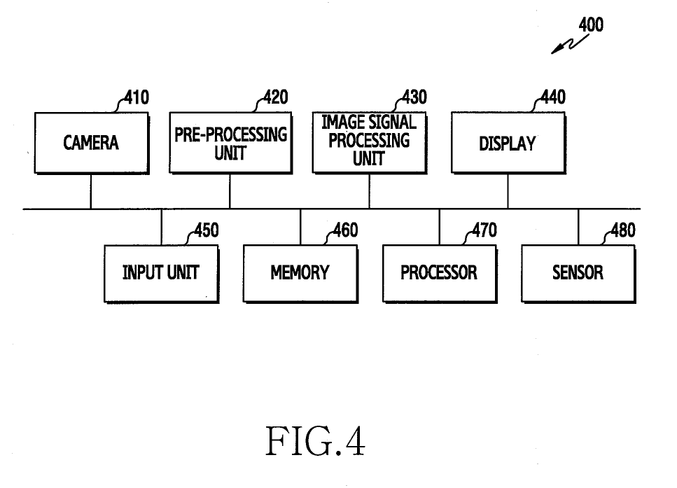

FIG. 4 is a schematic illustrating an electronic device for processing an image according to an embodiment of the present disclosure.

Referring to FIG. 4, the electronic device 400 may include a camera 410, a pre-processing unit 420, an image signal processing unit 430, a display 440, an input unit 450, a memory 460, a processor 470, and a sensor 480.

The camera 410 may include one or more cameras. The camera 410 may be located on a front surface or a rear surface of the electronic device, or may be located on both the front surface and the rear surface of the electronic device. The camera 410 may include a lens, an actuator, and an image sensor, etc. The camera 410 may acquire optical signals through the lens and convert the acquired optical signals into electric signals using the image sensor. The brightness of the image sensor may be determined by adjusting at least one of exposure time and/or gain.

The pre-processing unit 420 may perform a pre-processing operation on image data acquired from the image sensor of the camera 410. The pre-processing unit 420 may perform a pre-processing operation to compensate for exposure time so as to prevent the image from being degraded or to reduce degradation thereof, when the image signal processing unit located thereafter processes the image. The pre-processing unit 420 may perform the pre-processing operation to convert the image outputted from the image sensor into an RGB image by calculating an infra-frame sum. In addition, the pre-processing unit 420 may buffer the image outputted from the image sensor of the camera 410, set the image as a still image by calculating an inter-frame sum of the buffered images, and process the set image and store it as a still image. The pre-processing unit 420 may classify image data acquired in the camera 410 into a static image or a dynamic image, and process the image data. In the following description, a static image may be referred to as a captured image, a still image, or a high-pixel image, etc. In addition, a dynamic image may be referred to as a moving picture, a preview image of the camera, or a low-pixel image, etc.

The image signal processing unit 430 may process or further process the image as received from the pre-processing unit 420 to make it easy to display or store. The image signal processing unit 430 may perform processing including one or more of “3A” processing (auto exposure adjustment, auto focus adjustment, and auto white balance adjustment), noise reduction, image sharpening, demosaicking, color correction, edge enhancement, and gamma correction. The image signal processed in the image signal processing unit 430 may be displayed through the display 440 and may be stored in the memory 460 under the control of the processor 470. The pre-processing unit 420 may be included in the image signal processing unit 430 as determined by the type of the electronic device. In addition, the image signal processing unit 430 may be configured as a part of the processor 470 of the electronic device 400.

The display 440 may display the image signal processed in the image signal processing unit 430. The display 440 may display one or more of a captured image, a still image, a moving picture, or a camera preview image. The display 440 may be a liquid crystal display (LCD) or an organic light emitting diode (OLED).

The input unit 450 may detect an input to the electronic device. The input unit 450 may be a touch panel. The input unit 450 may detect a touch or hovering input by a user finger or a pen. The input unit 450 may cause inputs related to acquisition and processing of an image according to embodiments of the present disclosure.

The display 440 and the input unit 450 may be configured as an integrated touch screen.

The memory 460 may include one or more memories. The memory 460 may store the processed image signal. In addition, the memory 460 may store commands and programs for each of the modules of the electronic device (e.g., the pre-processing unit 420, the image signal processing unit 430, and the processor 470).

The processor 470 may be implemented by using a system on chip (SoC). The processor 470 may be divided and combined with other components of the electronic device (e.g., the camera 410, the display 440, and the sensor 480) if necessary or desirable. The processor 470 may control the other components of the electronic device and process data accompanied by the operations of the other components. In addition, the processor 470 may include a central processing unit (CPU) and a graphic processing unit (GPU).

The sensor 480 may include one or more sensors. For example, the sensor 480 may include at least one of a motion sensor, an acceleration sensor, a geomagnetic sensor, and a gyroscope sensor, etc. The sensor 480 may perform a function of detecting the state of the electronic device at the time of photographing by the camera.

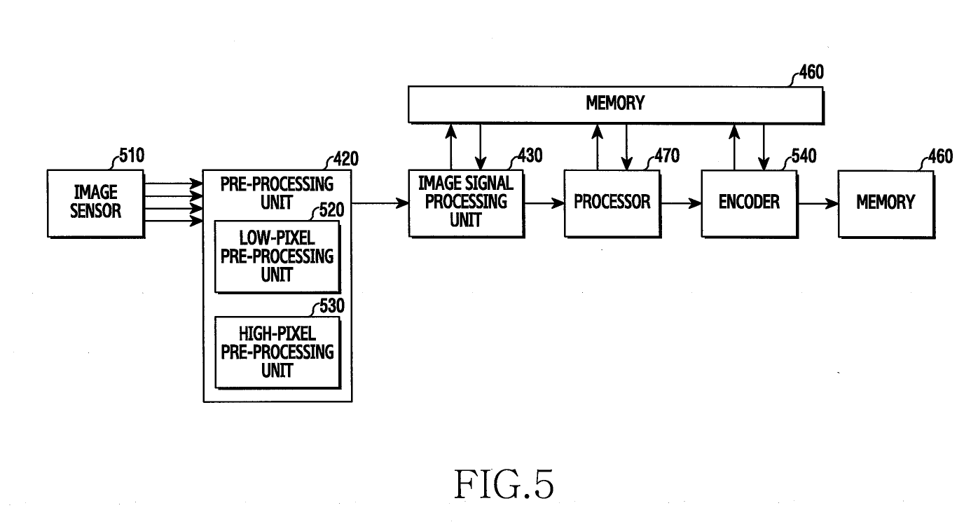

FIG. 5 is a block diagram illustrating a function of the electronic device according to embodiments of the present disclosure.

Referring to FIG. 5, an image sensor 510 may acquire image data. The image sensor 510 may convert optical signals entering through the lens of the camera 410 into electric signals, and may include one or more of a micro lens, a color filter, and an optical detector (e.g., a photo detector). The image sensor 510 may generate an image of a Bayer format. The image data resulting from the conversion of the optical signals into the electric signals by the image sensor 510 may be inputted to the pre-processing unit 420. The pre-processing unit 420 may perform image pre-processing of a different mode according to the type of the image data generated in the image sensor 510. Specifically, the pre-processing unit 420 may calculate an intra-frame sum or an inter-frame sum.

Herein, the intra-frame sum may include a method which generates a representative pixel by referring to information of adjacent pixels in the image. The intra-frame sum may convert an image of a Bayer format into an image of an RGB format by performing color interpolation and resizing. Additionally or alternatively, the intra-frame sum may include to a technique which is used for a dynamic image. The electronic device 400 can reduce a quantity of image processing operation by pre-processing based on the intra-frame sum, and can acquire an image that includes pixels with enhanced brightness.

Herein, the inter-frame sum may include a method which generates a representative pixel by referring to pixel information of different frame images regarding the same object. The inter-frame sum may include one or more of a demosaicking function which compares locations of an object in respective frames through a simplified operation, a motion estimation function which estimates a part where a motion occurs in the image by comparing a plurality of frames, a motion compensation function which generates an image with less blur by combining partial images that include no motion, or an image fusion function which generates a single piece of pixel information based on a plurality of pieces of frame or pixel information. In addition, the inter-frame sum may include a technique which is used for a static image. For example, the pre-processing unit 420 may generate an image including a representative pixel by calculating the inter-frame sum of pixels of a multi frame image which is configured in a time sequential pattern. In addition, the pre-processing unit 420 may generate an image including a representative pixel by calculating the inter-frame sum of pixels of an image acquired through a plurality of cameras. Through the above-described pre-processing, the electronic device 400 can reduce a quantity of image processing operations and acquire an image that includes pixels with enhanced brightness.

The pre-processing unit 420 may process the image data generated in the image sensor 510 according to an image processing mode. The image processing mode may include one or more of a preview mode, a moving picture processing mode, and a static image processing mode (e.g., still image processor mode or capture mode). The preview mode and the moving picture processing mode process by scaling images generated in the image sensor 510 to a predetermined pixel size. The static image processing mode, however, processes the images generated in the image sensor 510 as they are or by scaling the images to a predetermined size. Accordingly, an image size processed in the static image processing mode is large in comparison to the image size processed in the preview mode or the moving picture processing mode. Therefore, an image generated in the static image processing mode is a high resolution image. The pre-processing unit 420 may classify the image data according to the type of the image (e.g., a low-pixel image or a high-pixel image), and pre-process the image data.

When the generated image data is a low-pixel image, the generated image data may be inputted to a low-pixel pre-processing unit 520 of the pre-processing unit 420. The low-pixel pre-processing unit 520 may be referred to as a moving picture pre-processing unit. Similarly, in this disclosure, a low-pixel image may be referred to as a dynamic image or a preview image Furthermore, the low-pixel pre-processing unit 520 as disclosed herein may include a function of pre-processing a high-pixel dynamic image.

The low-pixel pre-processing unit 520 may pre-process the image by using the intra-frame sum. Specifically, the low-pixel pre-processing unit 520 may perform a pre-processing operation (e.g. image scaling) to reduce the size of the inputted image data, and transmit the image data to the image signal processing unit 540. The low-pixel image may be a moving picture or a camera preview image. The low-pixel pre-processing unit 520 may image-scale the image data of the Bayer pattern generated in the image sensor 510 to image data of an RGB pattern by calculating the intra-frame sum. Accordingly, the electronic device 400 can reduce the quantity of operation of image signals through the low-pixel pre-processing unit 520. In addition, the electronic device 400 can acquire an image that includes enhanced brightness while reducing a resolution through the low-pixel pre-processing unit 520.

When the generated image data is a high-pixel image, the image outputted from the image sensor 510 may be inputted to a high-pixel pre-processing unit 530. Herein, the high-pixel pre-processing unit 530 may be referred to as a static image pre-processing unit. In addition, in this disclosure, the high-pixel image may be referred to as a static image or a captured image. The high-pixel pre-processing unit 530 in this disclosure may include a function of pre-processing a low-pixel static image. The high-pixel pre-processing unit 530 may include a buffer configured to buffer the images generated in the image sensor 510. In addition, the high-pixel pre-processing unit 530 may pre-process the buffered images into a single still image by combining the images, and then transmit the still image to the image signal processing unit 430. The high-pixel pre-processing unit 530 can generate a bright image without losing exposure time or at least minimizing a loss thereof, by combining the plurality of images.

The image signal processing unit 430 which receives the pre-processed image from the pre-processing unit 420 may process the pre-processed image to convert into an image of a YUV format. In addition, the image signal processing unit 430 may transmit the image of the YUV format to the processor 470. In addition, the processor 470 may perform color matching and shading matching with respect to the image of the YUV format, and transmit the image to an encoder 540. The encoder 540 may compress the received image signals to be suitable to store (that is, encoding). The image encoded through the encoder 540 may be stored in the memory 460. The image signal processing unit 430, the processor 470, and the encoder 540 may receive commands from the memory 460 to perform operations.

According to embodiments of this disclosure, the electronic device 400 may convert the image of the Bayer format into the image of the RGB format through the elements shown in FIG. 5, and thus can reduce the amount of signal processing between the elements of the electronic device 400 (for e.g., the image signal processing unit 430, the memory 460, the processor 470, and the encoder 540).

In addition, according to embodiments of this disclosure, the electronic device 400 may perform motion estimation and image fusion prior to processing image signals through the elements shown in FIG. 5, and thus can reduce the quantity of operation of the processor 470. In response to the quantity of operation being reduced, the electronic device 400 may generate a post-processed image which is suitable to store or display using the processor 470.

Additionally, according to embodiments of this disclosure, the electronic device 400 can provide a bright image with short exposure.

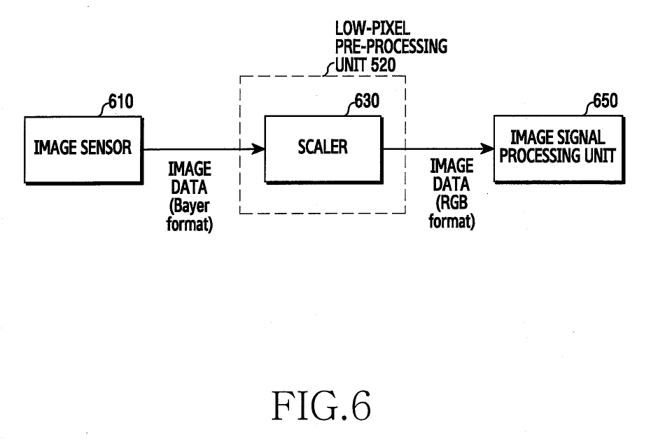

FIG. 6 is a schematic illustrating a low-pixel pre-processing unit according to embodiments of the present disclosure. Specifically, FIG. 6 illustrates a low-pixel pre-processing unit 520 which is implemented by using a scaler 630.

Referring to FIG. 6, an image sensor 610 may output image data of a Bayer format. A scaler 630 may generate pre-processed data by scaling the image data of the Bayer format to image data of an RGB format by calculating an intra-frame sum. The scaler 630 may scale the image data to a size of a desired resolution. The scaling may include an operation of performing nearest-neighbor and/or liner interpolation. In addition, the scaler 630 may scale by converting the format of the inputted image data. For example, the scaler 630 may convert the image of the Bayer format outputted from the image sensor 610 into the image data of the RGB format.

The image data outputted from the scaler 630 may be inputted to an image signal processing unit 650.

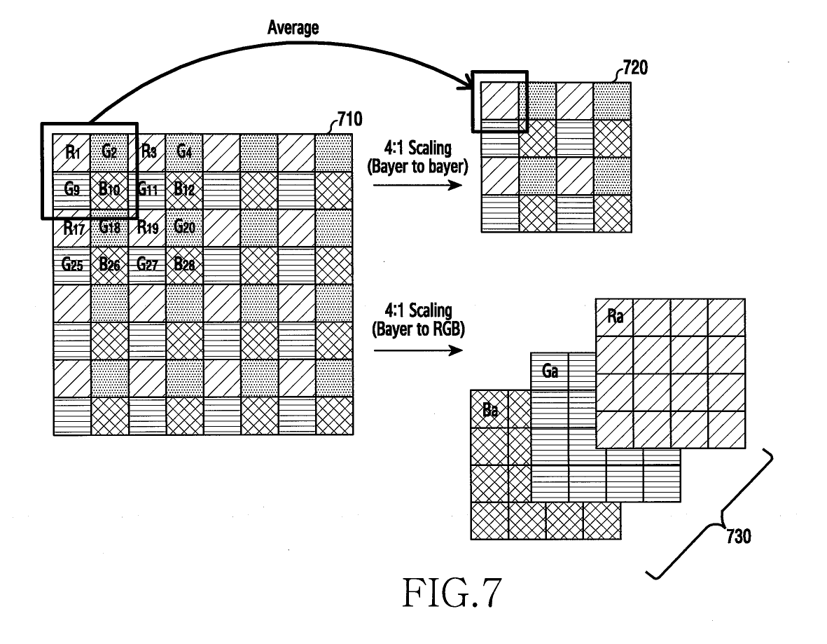

FIG. 7 is a schematic illustrating and operation of scaling an image using an image scaler according to embodiments of the present disclosure. FIG. 7 illustrates an example of pre-processing image data of a Bayer format into image data of an RGB format by calculating an intra-frame sum in the image scaler (that is, an example of pre-processing using an intra-frame sum).

Referring to FIG. 7, image data 710 may be image data of a Bayer format which is generated in the image sensor 610. The image data 710 may be scaled to an image of a Bayer format like image data 720 or may be scaled to an image of an RGB format like image data 730 in the image scaler. The image data 720 or image data 730 may be image data that includes a reduced number of pixels which is ¼ of the number of pixels of the image data 710.

The image data 730 may be a sum of sets of R pixels, G pixels, and B pixels which are reduced to ¼ of the number of pixels of the image data 710 of the Bayer format. In this case, the pixels forming the image data 730 may be determined by an intra-frame sum of adjacent pixels of the corresponding image data 710. For example, Ra may be determined by the intra-frame sum of R1, R3, R17, and R19, Ga may be determined by the intra-frame sum of G2, G4, G9, G11, G18, G20, G25, and G27, and Ba may be determined by the intra-frame sum of B10, B12, B26, and B28. Since the pixels of the image data 730 are determined by the intra-frame sum of the pixels of the image data 710, the brightness of the image data 730 may be four times higher than the brightness of the image data 720. Accordingly, the image data 730 can closer maintain the brightness of an original image even if exposure time is reduced to ¼. In addition, since the image data 730 is an image of low illuminance, a quantity of operation can be reduced in a subsequent image processing procedure.

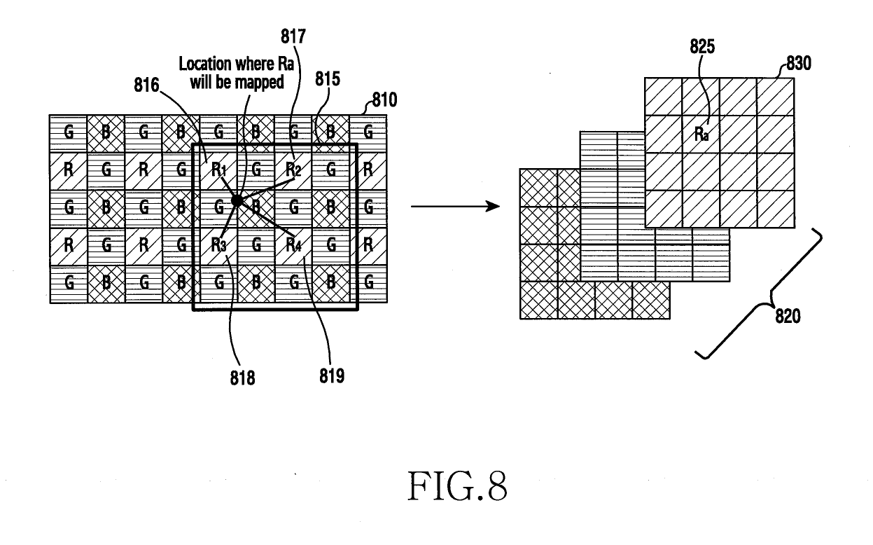

FIG. 8 is a schematic illustrating an example operation of generating an RGB image using an intra-frame sum according to embodiments of the present disclosure.

Referring to FIG. 8, image data 810 may be image data of a Bayer format. The image data 810 may correspond to the image data 710.

Image data 820 may be an image resulting from conversion of image data of a Bayer format into image data of an RGB format. The image data 820 may include a set of R pixels, a set of G pixels, and a set of B pixels. In FIG. 8, the image data 820 may be formed of three layers. However, this is merely an example for explanation. Additionally or alternatively, the image data 820 may be a single piece of image data.

The set of R pixels 830 of the image data 820 may be determined by the intra-frame sum of R pixels of the image data 810. The intra-frame sum may be calculated by adding up values of pixels located in a corresponding window. For example, when a window 815 including a part of the image data 810 is set, a value of Ra pixel 825 may be determined based on values of R1 pixel 816, R2 pixel 817, R3 pixel 818, and R4 pixel 819, which are included in the window 815. Accordingly, the value of Ra pixel 825 may be a sum of the values of R1 pixel 816, R2 pixel 817, R3 pixel 818, and R4 pixel 819 (that is, Ra=R1+R2+R3+R4).

In addition, the intra-frame sum may be calculated by weighting the values of the pixels in the window according to distances of the pixels. For example, the scaler 630 may determine the set of R pixels 830 by adding up the four pixels in the window 815. When the set of R pixels 830 is set (that is, image data is scaled by 4:1), at least one Ra pixel 825 included in the set of R pixels 830 may be determined by R1 pixel 816, R2 pixel 817, R3 pixel 818, and R4 pixel 819 included in the predetermined area 815 of the image data 810 and their corresponding weights. Therefore, Ra=R1 w1+R2 w2+R3 w3+R4 w4. Herein, w1, w2, w3, and w4 may be weights based on distances between Ra pixel 825 and respective R1 pixel 816, R2 pixel 817, R3 pixel 818, and R4 pixel 819. For example, the weights (e.g., w1, w2, w3, and w4) may have different values according to distance between Ra pixel and respective pixels corresponding to Ra pixel (e.g., R1, R2, R3, and R4). Accordingly, weight w1 which is related to R1 which is located at the closest location to a location where Ra will be mapped may have the greatest value from among w1, w2, w3, and w4. In addition, weight w4 which is related to R4 which is located at the farthest location from the location where Ra will be mapped may have the smallest value from among w1, w2, w3, and w4.

The weights may have various values according to desired brightness. For example, when it is desired that the set of R pixels 830 is four times brighter than the image data 810, the sum of weights w1, w2, w3, and w4 may be four (4). In addition, by adjusting the values of the weights, the electronic device 400 can acquire a relatively bright image without losing exposure time or at least minimizing loss thereof. For example, when the sum of w1, w2, w3, and w4 is four (4), new image data can maintain brightness even if the exposure time is reduced to ¼.

FIG. 8 illustrates an embodiment of the present disclosure where four adjacent pixels in the image data 810 are considered. However, embodiments based on more pixels may be considered according to settings. For example, an embodiment in which Ra is determined based on five or more adjacent pixels may be considered. In addition, as shown in FIG. 8, four pixels adjacent to pixel Ra are distinguished by dividing by a square area. However, this specific operation is implemented as an example for convenience of explanation and the pixels may be divided in other methods.

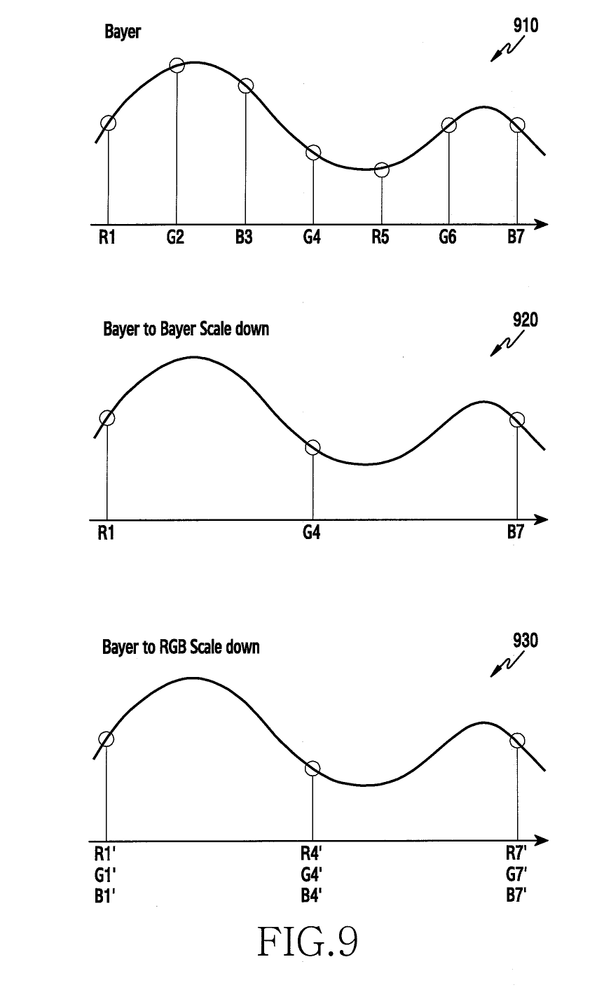

FIG. 9 is a schematic illustrating graphs displaying image data according to embodiments of the present disclosure.

Referring to FIG. 9, graph 910 may display original image data of a Bayer format (e.g., the image data 710 or the image data 810). In addition, graph 920 may display image data resulting from scaling of the original image of the Bayer format to an image of a Bayer format (Bayer to Bayer scale down) (e.g., the image data 720). In addition, graph 930 may display image data resulting from scaling of the original image of the Bayer format to an image of an RGB format (Bayer to RGB scale down) (e.g., the image data 730 or the image data 820).

The image data displayed on the graph 920 may not have information regarding other pixels (e.g., pixels R and B) at the location of a G4 pixel. However, the image data displayed on the graph 930 may have information regarding other pixels (e.g., pixels R4′ and B4′ on the graph 930) at the location of a G4′ pixel. In addition, the R4′ pixel may include information of R5 of the original image data (displayed on the graph 910) through interpolation, and the B4′ pixel may include a part of information of B3. Accordingly, the image data displayed on the graph 930 may include more pieces of information of the original image data (displayed on the graph 910) than the image data displayed on the graph 920.

Accordingly, when pre-processing a low-pixel image, the scaler 630 may scale image data generated from the image sensor to a resolution of an image to be finally generated. For example, the image sensor may generate a high-pixel image of a Bayer format (e.g., a 16 M pixel image), and the display 440 may display a relatively low-pixel image (e.g., a 2 M pixel image). In this case, the scaler 630 may scale (pre-process) the high-pixel image data to image data that includes a low-pixel RGB format by calculating the intra-frame sum, and transmit the scaled image data to the image signal processing unit 430. The low-pixel processing operation mode may be a preview mode and a moving picture processing mode.

According to embodiments of the present disclosure, the electronic device 400 can ensure, maintain, or otherwise minimize loss of brightness and resolution without losing exposure time or at least minimize loss thereof in the low-pixel processing mode. Accordingly, the electronic device can acquire an image that includes relatively less blur and noise in the preview mode or moving picture processing mode. In addition, according to embodiments of the present disclosure, the electronic device 400 can acquire a low-illuminance image through the scaler 630 and thus can reduce a quantity of operation in a subsequent image processing procedure.

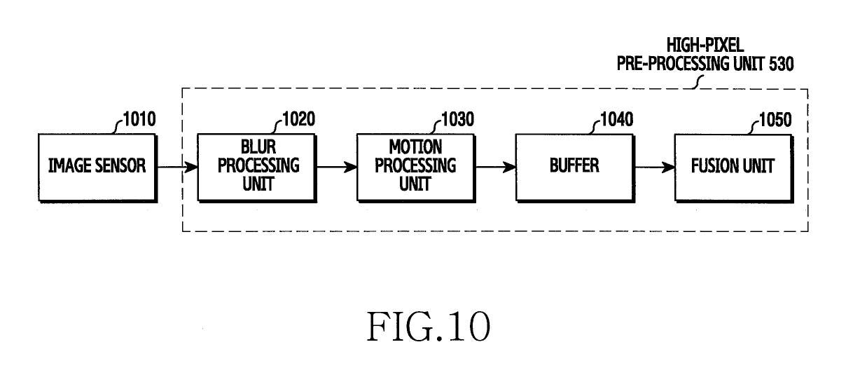

FIG. 10 is a block diagram illustrating a procedure for processing image data in the high-pixel pre-processing unit according to embodiments of the present disclosure.

Referring to FIG. 10, an image sensor 1010 may generate image data of a Bayer format. The image data generated by the image sensor 1010 may be inputted to a blur processing unit 1020.

The blur processing unit 1020 may estimate whether blur occurs in the image data (blur estimation). When the electronic device 400 moves, the blur may be included in the image generated in the image sensor 1010. The sensor 480 of the electronic device 400 may include a motion sensor. The motion sensor may be a sensor for detecting a motion of a device. The motion sensor may include an independent motion sensor or may detect a motion of a device using an acceleration sensor or a geomagnetic sensor. The blur processing unit 1020 may perform blur estimation using an image of a single frame or an image of a plurality of frames.

In addition, the blur processing unit 1020 may compensate for the blur included in the image data when the blur occurs in the inputted image data. Additionally, the blur processing unit 1020 may discard the image data when serious blur occurs in the inputted image data. For example, when blur occurs in original image data due to light scattering, internal processing of a camera, a motion of the electronic device, etc., the blur processing unit 1020 may estimate the blur and thereafter determine whether or not the blur is compensable base on the estimation. When the blur processing unit 1020 determines the blur is compensable, the blur processing unit 1020 compensates for the blur of the image. Alternatively, when the blur processing unit 1020 determines the blur is not compensable, the blur processing unit 1020 may discard the image data.

The image data outputted from the blur processing unit 1020 may be inputted to a motion processing unit 1030. Herein, the motion may be a motion of an object included in the image. The image generated in the image sensor 1010 may be continuous images and a moving object may be included in the continuous images. The motion processing unit 1030 may classify the continuous images into a reference image and comparison images. The reference image may be an image which includes an object that includes the least blur from among the continuous images processed in the blur processing unit 1020. In addition, the reference image may be an image of zero shutter lag without blur or with a negligible amount thereof, when compared to the other images in the continuous images, or an image without blur or with a negligible amount of blur which is closest to a zero shutter lag time. In addition, images classified as the comparison images may include all images except the image classified as the reference image data, from among the image data processed in the blur processing unit 1020. The motion processing unit 1030 may extract an area corresponding to a part of the object from the reference image, and may extract an area corresponding to the other part of the object from the comparison images. In addition, the motion processing unit 1030 may determine a motion of the reference image and a motion of the comparison image. Thereafter, the motion processing unit 1030 may correct a location regarding the other part of the comparison image based on the corresponding part of the reference image (that is, motion compensation).

A buffer 1040 may buffer the images processed in the motion processing unit 1030. The images stored in the buffer 1040 may be continuous images which have been generated in the image sensor 1010 and have been compensated for the blur and the motion in the blur processing unit 1020 and the motion processing unit 1030. The buffer 1040 may be a buffer which temporarily stores a predetermined number of frame images. For example, the buffer 1040 may be configured in the form of a circular buffer in which a plurality of frames is temporarily stored in order of acquisition.

A fusion unit 1050 may combine the images which are temporarily stored in the buffer 1040 at a time when image processing is requested. For example, when the electronic device 400 is requested to capture an image, the fusion unit 1050 may calculate the inter-frame sum of the image data stored in the buffer 1040. That is, the fusion unit 1050 may be configured to generate a single piece of image data through the inter-frame sum of the plurality of frames. Since the image data is generated by the inter-frame sum of n number of original image data, the brightness of the generated image data may be n times higher than the brightness of the original image data. Accordingly, the generated image data can maintain brightness of the image even if exposure time is reduced to 1/n. For example, the electronic device 400 may generate a single bright image by combining four (4) low-luminance images. Thus, since the electronic device 400 compensates for the motion of an image that includes less blur from among the plurality of acquired images, and calculates the inter-frame sum, a bright image including relatively less blur can be generated.

The high-pixel pre-processing unit 530 according to the configuration shown in FIG. 10 may generate an exposure-time-compensated image (pre-processed image) by combining images continuously generated in the image sensor 1010. In addition, the pre-processed high-pixel image may be a still image. In addition, the pre-processed high-pixel image may be stored as a still image. Accordingly, it is desirable that the high-pixel pre-processing unit 530 pre-processes after compensating for the blur and the motion of the image generated in the image sensor 1010. The image may have two kinds of motion components. One may be the motion of the device and the other one may be the motion of the object included in the image.

The high-pixel pre-processing unit 530 may estimate blur from at least one image from among the continuously generated images (blur estimation). The blur estimation may be performed using a deconvolution method. In addition, the motion estimation is estimating a motion from a photographed image, and may distinguish between a global motion which is generated by a motion of a terminal (including hand blur), and a local motion which is generated by a motion of an object in estimating the motion. The blur estimation may detect a motion vector of a terminal using the motion sensor. In addition, the blur estimation may detect a motion vector of some areas of an image through a block matching algorithm by comparing a plurality of images. In addition, the blur estimation may extract the local motion by combining the motion vector acquired from the image and the motion vector acquired from the motion sensor.

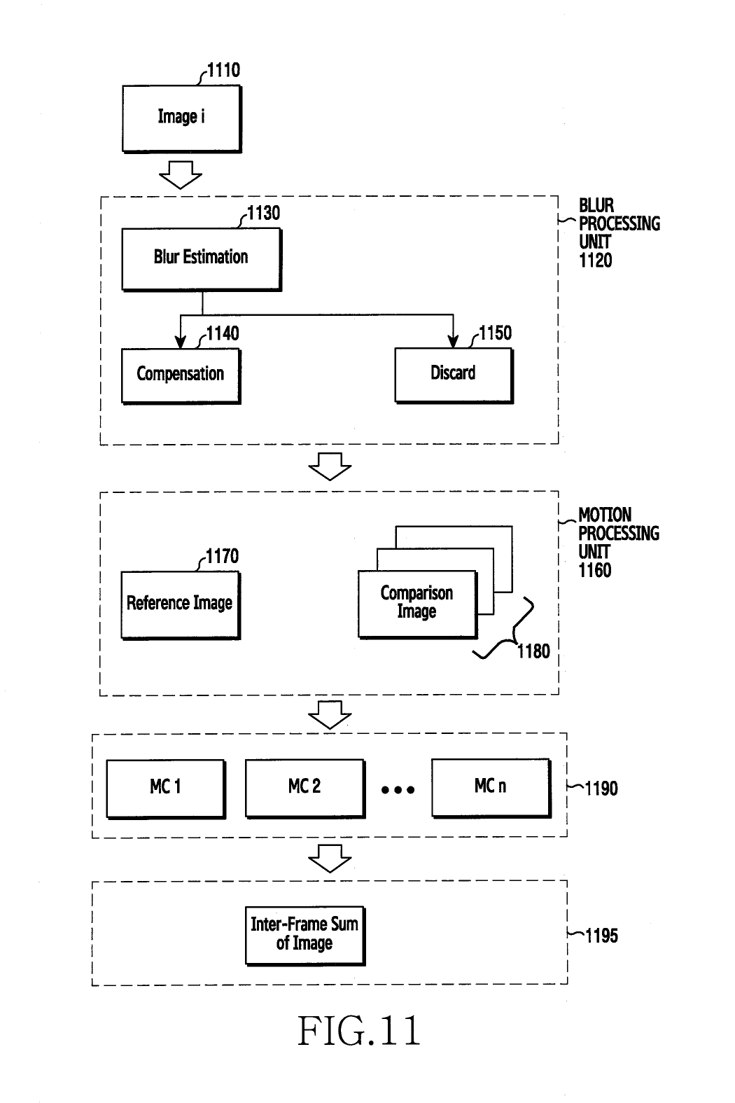

FIG. 11 is a block diagram illustrating a flow of images in the high-pixel pre-processing unit according to embodiments of the present disclosure. The operation procedure shown in FIG. 11 may include calculating an inter-frame sum.

Referring to FIG. 11, an image i of block 1110 is an image which is generated in the image sensor 510, and may be inputted to a blur processing unit 1120. When the image i of block 1110 is inputted to the blur processing unit 1120, the blur processing unit 1120 may estimate blur of the image i of block 1110 (1130). The image i of block 1110 may be outputted as it is, may be compensated for the blur (1140), or may be discarded (1150) according to a result of the estimating. The image which has been processed by the blur processing unit 1120 may be inputted to a motion processing unit 1160.

When the processed image is inputted to the motion processing unit 1160, the motion processing unit 1160 may classify the processed image into a reference image 1170 and a comparison image 1180. After classifying, the motion processing unit 1160 may estimate a motion with reference to the reference image 1170, and may transform the comparison image 1180 into the reference image 1170 through compensation (1190). The procedure of classifying into the reference image 1170 and the comparison image 1180 may be performed after the motion estimation is completed, if necessary or desirable.

When the electronic device 400 is requested to capture, the images which have been processed by the motion processing unit 1160 may undergo the inter-frame sum and may be applied to the image signal processing unit as a single pre-processed image 1195.

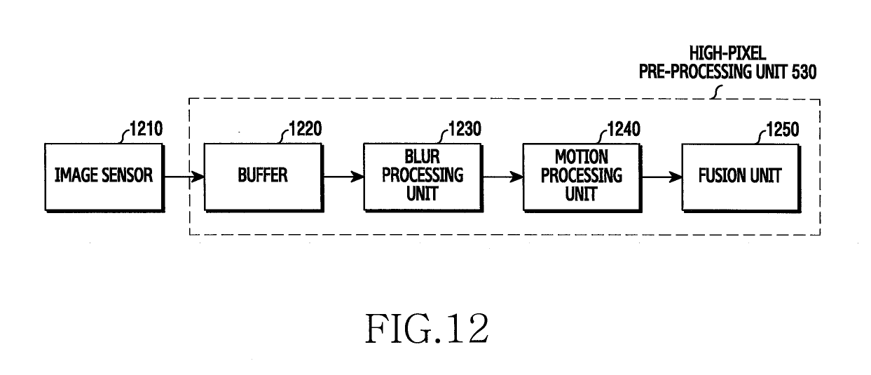

FIG. 12 is a block diagram illustrating a procedure for processing image data in the high-pixel pre-processing unit according to embodiments of the present disclosure.

Referring to FIG. 12, an image sensor 1210 may continue outputting image data of a Bayer format.

A buffer 1220 may buffer the image data. The buffer 1220 may be a buffer (e.g., a ring buffer) which stores a predetermined number of frame images generated in the image sensor 1210.

A blur processing unit 1230 may estimate blur of the image data temporarily stored in the buffer 1220, compensate for the blur, or discard the image data.

A motion processing unit 1240 may estimate a motion of the image data which has been processed by the blur processing unit 1230, and compensate for the motion.

Finally, a fusion unit 1250 may calculate an inter-frame sum with respect to the image data which has been processed in the motion processing unit 1240.

The high-pixel pre-processing unit 530 according to the configuration shown in FIG. 12 may combine the plurality of motion compensated images and output a pre-processed still image at the time when the electronic device is requested to capture. In this case, the time to combine the plurality of images may be determined in the following methods.

First, the buffer 1220 buffers the images generated in the image sensor 1210. When the electronic device is requested to capture, the blur processing unit 1230 determines whether there is blur in the buffered images, and the motion processing unit 1240 selects a reference image from among the inputted images, compares the reference image and the other images, and compensates for a motion in the images. In addition, the motion processing unit 1240 combines the motion compensated images and output the image.

Second, the buffer 1220 buffers the images generated in the image sensor 1210, and the blur processing unit 1230 determines whether there is blur in the buffered images. In addition, the motion processing unit 1240 selects a reference image from among the inputted images, compares the reference image and the other images, compensates for the motion in the image, and then stores the image in the buffer. When the electronic device is requested to capture, the fusion unit 1250 combines the motion compensated images which are buffered and outputs the image.

Herein, the reference image may be a zero shutter lag image or an image which is closest to the zero shutter lag and that includes least blur when blur exists in the zero shutter lag image.

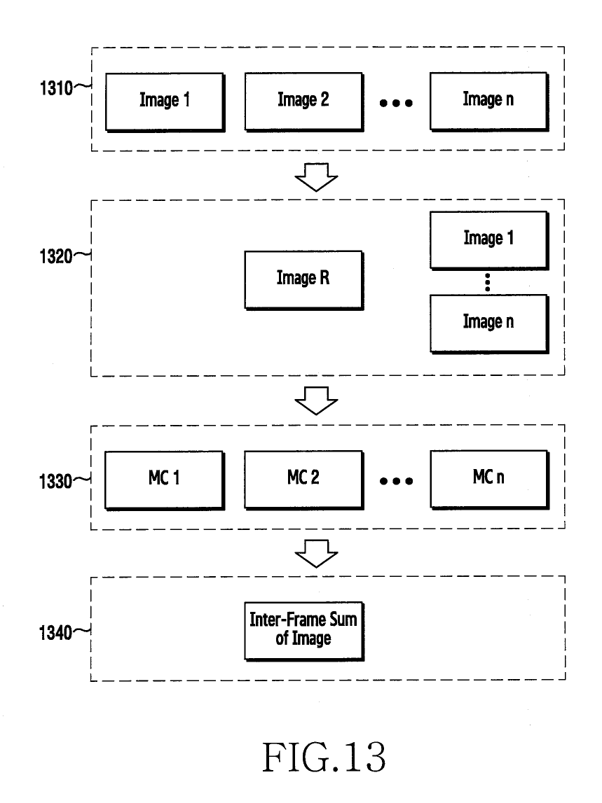

FIG. 13 is a block diagram illustrating a flow of images in the high-pixel pre-processing unit according to embodiments of the present disclosure.

Referring to FIG. 13, the high-pixel pre-processing unit may store n number of images in the buffer 1220 in block 1310. Thereafter, the high-pixel pre-processing unit may select an image of an object that includes least blur from among the n number of images temporarily stored in the buffer 1220 as a reference image through blur processing, and select other images except a discarded image from among the n number of images as comparison images (e.g. Image 1, . . . , Image n).

Next, the high-pixel pre-processing unit performs motion estimation by comparing the reference image and the comparison images in block 1320. There may be a difference between the time at which the reference image is acquired and the time at which the comparison images are acquired. During the time difference, the object included in both images may move. Accordingly, the high-pixel pre-processing unit may estimate such a motion of the object in block 1320. Such motion estimation provides a basis for motion compensation in a subsequent procedure.

When the motion estimation is completed, the high-pixel pre-processing unit may compensate for the motion of the images in block 1330. Thereafter, when the electronic device 400 is requested to capture, the high-pixel pre-processing unit may calculate an inter-frame sum of the images in block 1340.

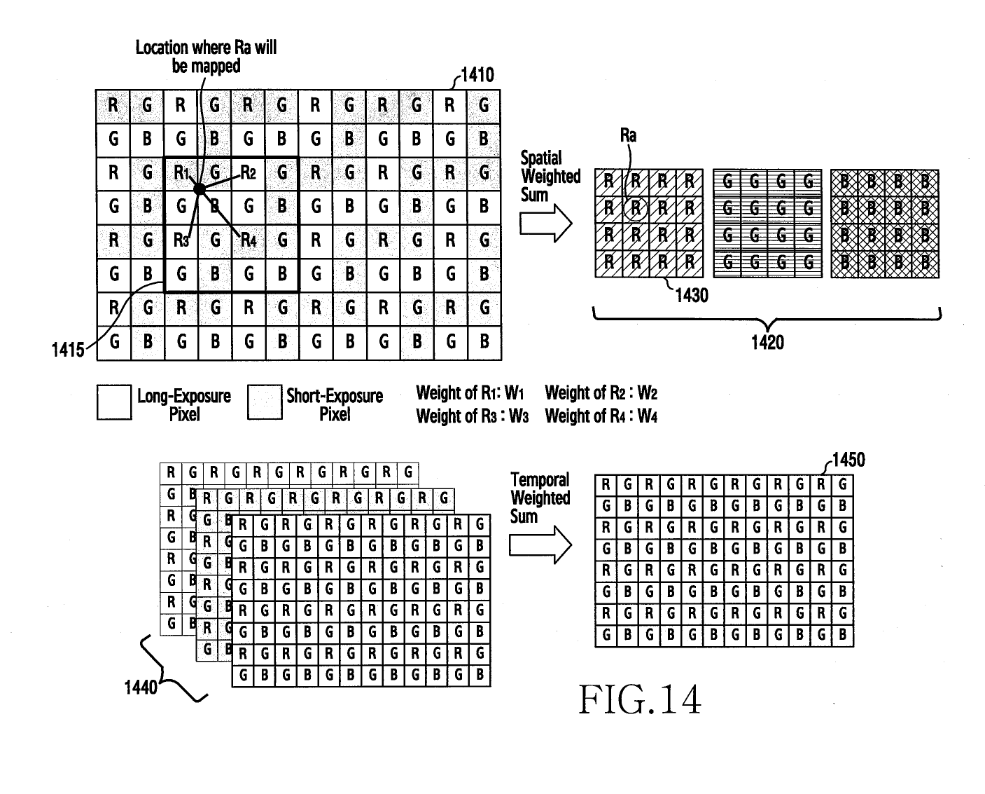

FIG. 14 is a schematic illustrating image data to which a high dynamic range (HDR) effect is applied according to embodiments of the present disclosure.

Referring to FIG. 14, image data 1410 may be original image data to which the HDR effect is applied (e.g., image data that includes different exposure in each pixel). The original image data 1410 may include long-exposure pixels and short-exposure pixels to achieve the HDR effect.

A set of R pixels 1430 in image data 1420 may be determined by an intra-frame sum of weighted R pixels of the image data 1410 (including both the long-exposure pixels and the short-exposure pixels). The weights may have different values according exposure time unlike in FIG. 8. For example, in the case of FIG. 8, w1 is of the greatest weight, but in the case of image data 1420, w2 or w3 corresponding to long-exposure pixels may be of the greatest weight. This is because the weights w2 and w3 of the long-exposure pixels are higher than weights w1 and w4 of the short-exposure pixels.

Image data 1440 may be a set of original image data to which the HDR effect is applied (e.g., a set of image data that includes different exposure time for each layer). The image data 1440 may have a sequence relationship in time. In addition, the image data 1440 may be images which are photographed by different cameras simultaneously. Accordingly, the image data 1440 may be stored in the buffer of the electronic device 400.

Image data 1450 may be image data which is configured by the inter-frame sum of the image data 1440. The image data 1450 differs from the image data 1195 in that image data at various points of time that includes different exposure times are combined into a single image. Specifically, when it is determined that a specific pixel in the image data 1450 corresponds to a relatively dark area in the entire image, the contrast of the dark area may increase by increasing the weight of the long-exposure pixel. The image data 1450 may be an image resulting from this process. In addition, when it is determined that a specific pixel in the image data 1450 corresponds to a relatively bright area in the entire image, the contrast of the bright area may increase by increasing the weight of the short-exposure pixel. The image data 1450 may be an image resulting from this process.

According to embodiments of the present disclosure described above, an electronic device includes: an image sensor configured to acquire one or more images including an object; a pre-processing unit configured to generate one or more pre-processed images by changing a part of the one or more pre-processed images; and an image signal processing unit configured to generate a post-processed image by changing a part of the one or more pre-processed images. The one or more images may include an image of a Bayer format, and the one or more pre-processed images may include an image of an RGB format. The pre-processing unit may be configured to generate the one or more pre-processed images by combining the one or more images, and data capacity of the one or more pre-processed images may be smaller than data capacity of the one or more images.

In addition, the one or more images may include a plurality of images including a first image and a second image. The pre-processing unit may be configured to generate the one or more pre-processed images by extracting a first area corresponding to a part of the object from the first image, extracting a second area corresponding to the other part of the object from the second image, and combining the first area and the second area. The combining the first area and the second area may determine a first motion regarding the first area or a second motion regarding the second area, and may perform motion compensation with respect to a corresponding image of the first image or the second image based on the first motion or the second motion.

The pre-processing unit may be configured to generate the one or more pre-processed images by down-scaling the one or more images with respect to one or more colors. The one or more colors may include a first color and a second color, and the down-scaling may extract a plurality of first color values corresponding to the first color from the one or more images, and extract a plurality of second color values corresponding to the second color from the one or more images. The pre-processing unit may be configured to generate the one or more pre-processed images by combining the one or more images based on the first color values and the second color values.

In addition, the pre-processing unit may be configured to pre-process the one or more images by performing one or more operations of demosaicking, motion estimation, motion compensation, or image fusion.

In addition, the image signal processing unit may be configured to generate the post-processed image by performing one or more operations of an operation of adjusting white balance, an operation of adjusting color, or an operation of adjusting noise with respect to at least part of the one or more pre-processed images.

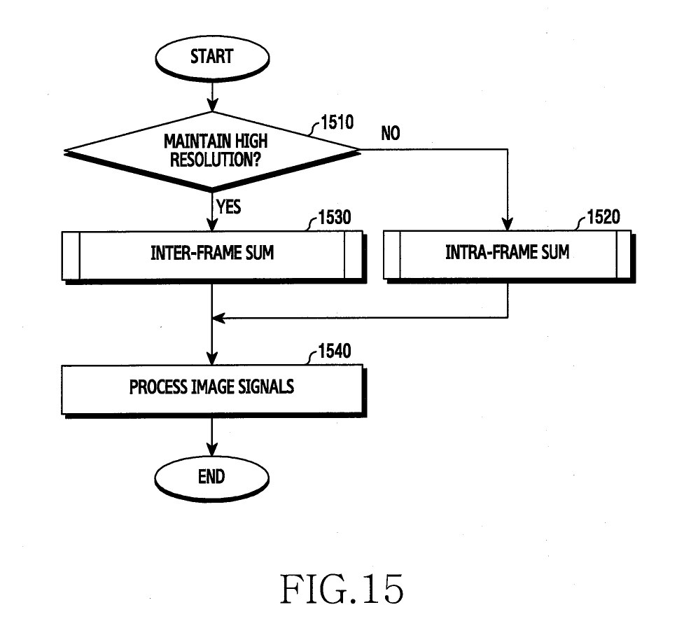

FIG. 15 is a flowchart illustrating an operation of an electronic device which processes image data according to embodiments of the present disclosure.

Referring to FIG. 15, the electronic device 400 may determine whether to maintain high pixels like original image data (that is, whether it is necessary or desirable to adjust the number of pixels of original image data (image data outputted from the image sensor)). The adjusting the number of pixels may refer to down-scaling the number of pixels of an image generated in the image sensor. It is common that the number of pixels of an image generated in the image sensor is greater than the number of pixels displayed on the display 440. Accordingly, in a preview mode, the electronic device 400 may adjust the number of pixels of the image generated in the image sensor (e.g., down-scaling), and process the image. In addition, in a moving picture processing mode, the electronic device 400 may down-scale moving picture images generated in the image sensor, and may process the images. However, when a still image is captured, the electronic device 400 may process the images generated in the image sensor without scaling the number of pixels of the images. Accordingly, operation 1510 may be an operation of determining where the original image data is to be processed (e.g., the low-pixel pre-processing unit 520 or the high-pixel pre-processing unit 530).

When it is necessary or desirable to adjust the number of pixels of the original image data (e.g., low-pixel image data, a moving picture, and a camera preview image), the electronic device 400 may calculate an intra-frame sum of the original image data in operation 1520. Alternatively, when it is not necessary or desirable to adjust the number of pixels of the original image data (e.g., high-pixel image data, a still image, and a captured image), the electronic device 400 may calculate an inter-frame sum of the original image data in operation 1530.

The image data pre-processed in operation 1520 or operation 1530 may be processed to be suitable to display or store in operation 1540.

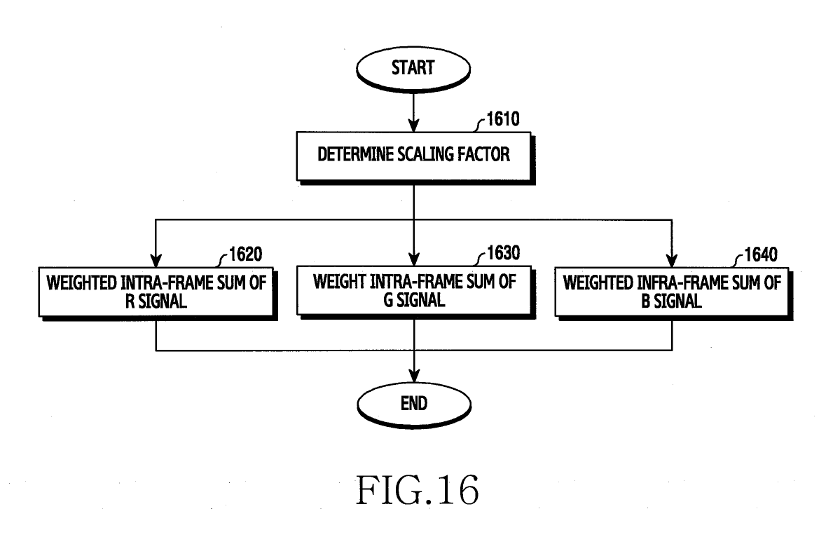

FIG. 16 is a flowchart illustrating an operation of calculating an intra-frame sum of the low-pixel pre-processing unit according to embodiments of the present disclosure.

Referring to FIG. 16, the electronic device 400 may determine a scaling factor in operation 1610. The scaling factor may refer to a ratio for adjusting the number of pixels. For example, in the embodiments shown in FIGS. 7 and 8, image data of an RGB format is generated considering four adjacent pixels. Therefore, the scaling factor would be four (4). When the scaling factor is determined in operation 1610, the electronic device 400 may calculate intra-frame sums of weighted pixels (e.g., R, G, and B pixels) according to the scaling factor in operations 1620-1640.

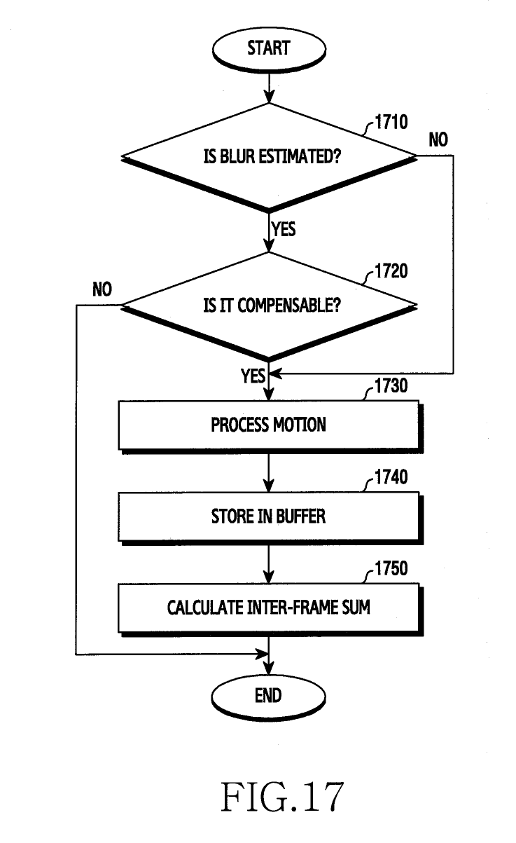

FIG. 17 is a flowchart illustrating an operation of calculating an inter-frame sum of the high-pixel pre-processing unit according to embodiments of the present disclosure.

Referring to FIG. 17, the electronic device may estimate blur in image data in operation 1710. When the blur of the image data is lower than a predetermined reference value, the electronic device 400 may select the image data as reference image data.

However, when the blur of the image data is higher than the predetermined reference value, the electronic device 400 may determine whether it is possible to compensate for the blur in operation 1720. When it is near impossible to compensate for the blur of the image data, the electronic device 400 may discard the corresponding image data. However, when it is possible to compensate for the blur of the image data, the electronic device 400 may compensate for the blur of the image data and select the corresponding image data as comparison image data.

When it is determined that the blur can be compensated for in operation 1720, the electronic device 400 may perform a motion processing operation in operation 1730. The motion processing operation may include at least one of motion estimation or motion compensation.

When the motion processing operation is completed in operation 1730, the electronic device 400 may store the processed image data in a buffer in operation 1740. Thereafter, the electronic device 400 may calculate an inter-frame sum using the image data stored in the buffer in operation 1750.

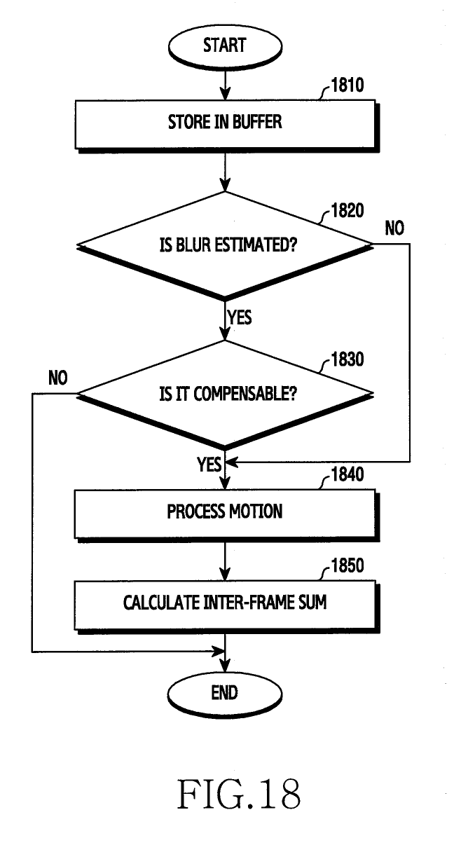

FIG. 18 is a flowchart illustrating another operation of calculating an inter-frame sum of the high-pixel pre-processing unit according to embodiments of the present disclosure. The operation procedure shown in FIG. 18 may be controlled by the high-pixel pre-processing unit 530.

Referring to FIG. 18, the electronic device 400 may temporarily store image data in a buffer in operation 1810. Thereafter, the electronic device 400 may perform blur estimation based on the temporarily stored image data in operation 1820. The electronic device 400 may select image data that includes least blur from among the image data as reference image data.

When blur is estimated in the image data, the electronic device 400 may determine whether it is possible to compensate for the blur in operation 1830. When it is near impossible to compensate for the blur of the image data, the electronic device 400 may discard the corresponding image data. However, when it is possible to compensate for the blur of the image data, the electronic device 400 may compensate for the blur of the image data and select the image data as comparison image data.

When it is determined that the blur can be compensated for in operation 1830, the electronic device 400 may perform a motion processing operation in operation 1840. When the motion processing operation is completed in operation 1840, the electronic device 400 may calculate an inter-frame sum using the processed image data in operation 1850.

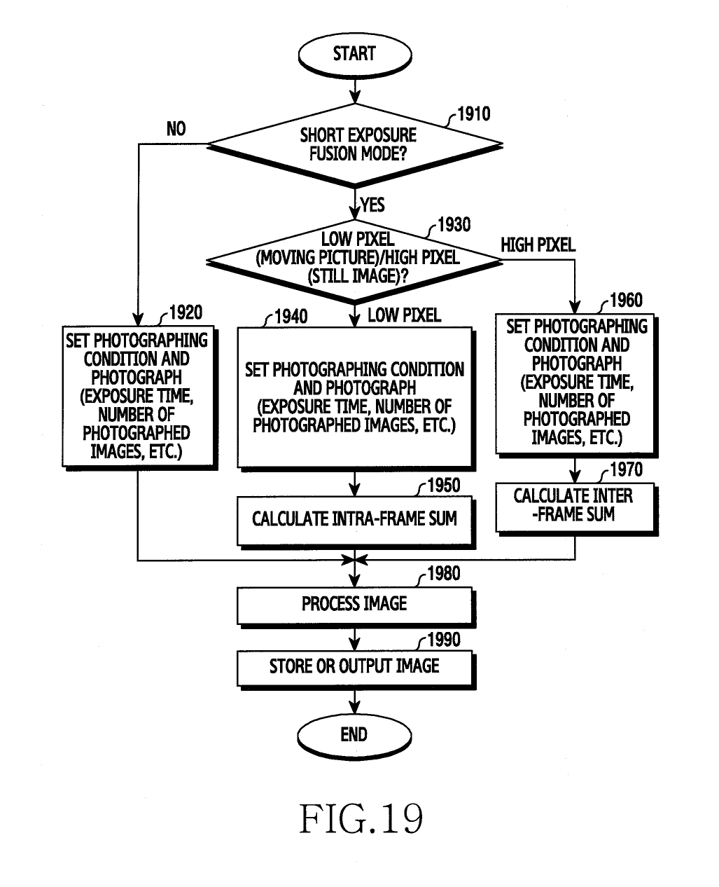

FIG. 19 is a flowchart illustrating an operation of the electronic device according to embodiments of the present disclosure. The operation procedure shown in FIG. 19 may be controlled in the pre-processing unit 420, the image signal processing unit 430, and/or the processor 470.

Referring to FIG. 19, the electronic device 400 may ask the user whether a short exposure fusion mode will be used or not in operation 1910. When an exposure time fusion mode disuse intention is inputted, the electronic device 400 may set a photographing condition and photograph an image in operation 1920.

However, when an exposure time fusion mode use intention is inputted, the electronic device 400 may determine whether it is necessary or desirable to adjust the number of pixels of an original image in operation 1930.

When it is necessary or desirable to adjust the number of pixels like with a moving picture or a preview image of a camera, the electronic device 400 may set a photographing condition and photograph image in operation 1940. Thereafter, the electronic device 400 may calculate an intra-frame sum (e.g., low-pixel pre-processing through scaling) in operation 1950.

Alternatively, when it is not necessary or desirable to adjust the number of pixels as with a still image or a captured image, or when a plurality of images are photographed by a plurality of cameras simultaneously, the electronic device 400 may set a photographing condition and photograph an image in operation 1960. Thereafter, the electronic device 400 may calculate an inter-frame sum (e.g., high-pixel pre-processing through multi frame fusion) in operation 1970.

When any of operations 1920, 1950, or 1970 is completed, the electronic device 400 performs image processing in operation 1980. The image data which is processed to be suitable to display or store through image processing may be displayed on the display 440 or stored in the memory 460 in operation 1990.

The operation of the electronic device 400 according to embodiments of the present disclosure may perform set pre-processing with respect to the image acquired through the image sensor 510 through the pre-processing unit 420. Thereafter, the electronic device 400 may post-process the pre-processed image in the image processing unit 430.

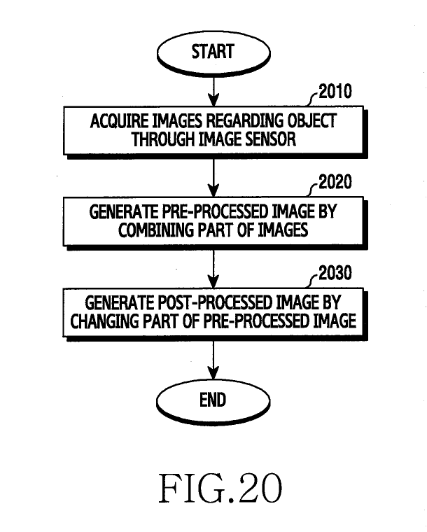

FIG. 20 is a flowchart illustrating an operation of the electronic device according to embodiments of the present disclosure.

Referring to FIG. 20, the electronic device 400 may acquire one or more images regarding an object through the image sensor 510 in operation 2010. In this case, the one or more acquired images may be of a Bayer format. Thereafter, the electronic device 400 may generate one or more pre-processed images by combining an entirety or a part of the one or more acquired images through an intra-frame sum or an inter-frame sum in operation 2020. The electronic device 400 can generate a bright image with relatively less exposure through this combining operation (operation 2020). In addition, the electronic device 400 can reduce a quantity of operation in a subsequent image processing procedure through this combining operation. When operation 2020 is completed, the electronic device 400 may generate a post-processed image by changing a part of the one or more pre-processed images. The post-processed image may be generated by performing one or more operations of a “3A” processing operation (auto exposure adjustment, auto focus adjustment, auto white balance adjustment), a noise reduction operation, an image sharpening operation, a demosaicking operation, a color correction operation, an edge enhancement operation, or a gamma correction operation with respect to the one or more pre-processed images.

According to embodiments of the present disclosure, an operation method of an electronic device which includes a pre-processing unit and an image signal processing unit includes: acquiring one or more images regarding an object through an image sensor operatively connected with the electronic device; generating, by the pre-processing unit, one or more pre-processed images by changing a part of the one or more images; and generating, by the image signal processing unit, a post-processed image by changing a part of the one or more pre-processed images. The one or more images may include an image of a Bayer format, and the one or more pre-processed images may include an image of an RGB format.

In addition, the generating the one or more pre-processed images may include generating the one or more pre-processed images by combining the one or more images, and data capacity of the one or more pre-processed images may be smaller than data capacity of the one or more images.

In addition, the one or more images may include a plurality of images including a first image and a second image. The generating the one or more pre-processed images may include: extracting a first area corresponding to a part of the object from the first image; extracting a second area corresponding to the other part of the object from the second image; and combining the first area and the second area. The combining may include: determining a first motion regarding the first area or a second motion regarding the second area; and performing motion compensation with respect to a corresponding image of the first image or the second image based on the first motion or the second motion.

In addition, the generating the one or more pre-processed images may include down-scaling the one or more images with respect to one or more colors. The one or more colors may include a first color and a second color, and the down-scaling may include: extracting a plurality of first color values corresponding to the first color from the one or more images; extracting a plurality of second color values corresponding to the second color from the one or more images; and combining the one or more images based on the first color values and the second color values.

In addition, the generating the one or more pre-processed images may include performing one or more operations of demosaicking, motion estimation, motion compensation, or image fusion.

The generating the post-processed image may include performing one or more operations of an operation of adjusting white balance, an operation of adjusting color, or an operation of adjusting noise with respect to at least part of the pre-processed image.

According to embodiments of the present disclosure, the electronic device can reduce exposure time and also solve or improve noise and blur of an image. According to embodiments of the present disclosure, the electronic device can have an effect of reducing exposure time using an intra-frame sum or spatial sum in an image scaling operation when the image is a preview image or a moving picture, and using an inter-frame sum or temporal sum when the image is a captured image or a still image. In addition, in executing the image scaling operation, the electronic device can ensure, maintain, or otherwise minimize loss of brightness and resolution simultaneously using a Bayer to RGB conversion method rather than a Bayer to Bayer conversion method.

According to embodiments of the present disclosure, the electronic device performs a different processing operation according to whether an image is a preview image, a moving picture, or a still image, so that noise and blur problems can be solved or minimized simultaneously without actually increasing exposure time.

The electronic device and the operation method thereof according to embodiments of the present disclosure can acquire a bright image while reducing exposure time in the image pre-processing process, and also can reduce blur.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which are known or are to be developed hereinafter.

According to embodiments, at least some of the devices (for example, modules or functions thereof) or the method (for example, operations) according to the present disclosure may be implemented by a command stored in a computer-readable storage medium in a program module form. The instruction, when executed by a processor (e.g., the processor 120), may cause the one or more processors to execute the function corresponding to the instruction. The computer-readable recoding media may be, for example, the memory 130.

The computer readable recoding medium may include a hard disk, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a read only memory (ROM), a random access memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

Any of the modules or program modules according to embodiments of the present disclosure may include at least one of the above described elements, exclude some of the elements, or further include other additional elements. The operations performed by the modules, program module, or other elements according to various embodiments of the present disclosure may be executed in a sequential, parallel, repetitive, or heuristic manner. Further, some operations may be executed according to another order or may be omitted, or other operations may be added.

Although the present disclosure describes some embodiments, various changes and modifications may be suggested to one skilled in the art. It is intended that the present disclosure encompass such changes and modifications as fall within the scope of the appended claims.

What is claimed is:

1. A method of operating an electronic device, the method comprising:
acquiring one or more images of an object using an image sensor operatively connected with an electronic device, wherein the electronic device comprises a pre-processing unit and an image signal processing unit;
generating, using the pre-processing unit, one or more pre-processed images by changing a first part of the one or more images; and
generating, using the image signal processing unit, a post-processed image by changing a second part of the one or more pre-processed images.

2. The method of claim 1, wherein the one or more images comprise an image of a Bayer format, and
wherein the one or more pre-processed images comprise an image of an RGB format.

3. The method of claim 1, wherein the generating the one or more pre-processed images comprises generating the one or more pre-processed images by combining the one or more images, and
wherein data capacity of the one or more pre-processed images is smaller than data capacity of the one or more images.

4. The method of claim 1, wherein the one or more images comprise a plurality of images comprising a first image and a second image.

5. The method of claim 4, wherein the generating the one or more pre-processed images comprises:
extracting a first area corresponding to a part of the object from the first image;
extracting a second area corresponding to the other part of the object from the second image, wherein the other part is a remaining part of the object not including the first part; and
combining the first area and the second area.

6. The method of claim 5, wherein the combining comprises:
determining a first motion regarding the first area or a second motion regarding the second area; and
performing motion compensation with respect to a corresponding image of the first image or the second image based on the first motion or the second motion.

7. The method of claim 1, wherein the generating the one or more pre-processed images comprises down-scaling the one or more images with respect to one or more colors.

8. The method of claim 7, wherein the one or more colors comprise a first color and a second color, and
wherein the down-scaling comprises:
extracting a plurality of first color values corresponding to the first color from the one or more images;
extracting a plurality of second color values corresponding to the second color from the one or more images; and
combining the one or more images based on the first color values and the second color values.

9. The method of claim 1, wherein the generating the one or more pre-processed images comprises performing one or more operations of demosaicking, motion estimation, motion compensation, or image fusion.

10. The method of claim 1, wherein the generating the post-processed image comprises performing one or more operations of an operation of adjusting white balance, an operation of adjusting color, or an operation of adjusting noise with respect to at least part of the pre-processed image.

11. An electronic device comprising:
an image sensor configured to acquire one or more images of an object;
a pre-processing unit configured to generate one or more pre-processed images by changing a first part of the one or more images; and
an image signal processing unit configured to generate a post-processed image by changing a second part of the one or more pre-processed images.

12. The electronic device of claim 11, wherein the one or more images comprise an image of a Bayer format, and
wherein the one or more pre-processed images comprise an image of an RGB format.

13. The electronic device of claim 11, wherein the pre-processing unit is configured to generate the one or more pre-processed images by combining the one or more images, and
wherein data capacity of the one or more pre-processed images is smaller than data capacity of the one or more images.

14. The electronic device of claim 11, wherein the one or more images comprise a plurality of images comprising a first image and a second image.

15. The electronic device of claim 14, wherein the pre-processing unit is configured to generate the one or more pre-processed images by extracting a first area corresponding to a part of the object from the first image, extracting a second area corresponding to the other part of the object from the second image, and combining the first area and the second area.

16. The electronic device of claim 15, wherein the combining the first area and the second area determines a first motion regarding the first area or a second motion regarding the second area, and performs motion compensation with respect to a corresponding image of the first image or the second image based on the first motion or the second motion.

17. The electronic device of claim 11, wherein the pre-processing unit is configured to generate the one or more pre-processed images by down-scaling the one or more images with respect to one or more colors.

18. The electronic device of claim 17, wherein the one or more colors comprise a first color and a second color,
wherein the down-scaling extracts a plurality of first color values corresponding to the first color from the one or more images, and extracts a plurality of second color values corresponding to the second color from the one or more images, and
wherein the pre-processing unit is configured to generate the one or more pre-processed images by combining the one or more images based on the first color values and the second color values.

19. The electronic device of claim 11, wherein the pre-processing unit is configured to pre-process the one or more images by performing one or more operations of demosaicking, motion estimation, motion compensation, or image fusion.

20. The electronic device of claim 11, wherein the image signal processing unit is configured to generate the post-processed image by performing one or more operations of an operation of adjusting white balance, an operation of adjusting color, or an operation of adjusting noise with respect to at least part of the one or more pre-processed images.
